(19) United States
(12) Patent Application Publication
(10) Pub. No.: US 2025/0091371 A1
(43) Pub. Date: Mar. 20, 2025

(54) IMAGE FORMING METHOD, IMAGE FORMING APPARATUS, AND IMAGE FORMING SYSTEM

(71) Applicant: Masanori HIRANO, Kanagawa (JP)

(72) Inventor: Masanori HIRANO, Kanagawa (JP)

(21) Appl. No.: 18/823,892

(22) Filed: Sep. 4, 2024

(30) Foreign Application Priority Data
Sep. 14, 2023 (JP) 2023-149388

(51) Int. Cl. B41J 25/00; B41J 2/21; B41J 3/407; B41J 11/00; D06P 5/00; D06P 5/20; D06P 5/30

(52) U.S. Cl. CPC B41J 25/001; B41J 2/2117; B41J 3/4078; B41J 11/0022; D06P 5/002; D06P 5/2077; D06P 5/30

(57) ABSTRACT

An image forming method includes applying a pretreatment liquid to a first area on an object having permeability, applying ink to the first area applied with the pretreatment liquid to form an image in the first area, the ink containing an organic solvent seeping into a second area around a circumference of the image in the first area and applying a colorless liquid containing water to the second area to diffuse the organic solvent in the second area.

### CROSS-REFERENCE TO RELATED APPLICATIONS

This patent application is based on and claims priority pursuant to 35 U.S.C. § 119(a) to Japanese Patent Application No. 2023-149388, filed on Sep. 14, 2023, in the Japan Patent Office, the entire disclosure of which is hereby incorporated by reference herein.

### BACKGROUND

### Technical Field

Embodiments of the present disclosure relate to an image forming method, an image forming apparatus, and an image forming system.

### Related Art

DTG (Direct to Garment) printing is known that directly discharges ink onto a cloth using an inkjet technology to perform printing. In the DTG printing, to firmly fix a coloring agent to the cloth, which is an object to be printed, a process is performed in which a pretreatment liquid is applied before printing. Applying the pretreatment liquid to the cloth allows an ink containing a white pigment, which is difficult to be fixed to fibers of the cloth, and a polyester fiber to which the ink is difficult to be fixed, to be employed.

In the related art, after the pretreatment liquid is applied, the ink is dried once by a heating and pressing device, then printing is performed, and the ink is heated and pressed again to fix the ink to a cloth. Currently, an image forming apparatus having a pretreatment-liquid discharge head incorporated in the image forming apparatus has been developed for the purpose of shortening the above-described process and increasing productivity. In such an image forming apparatus, the application of the pretreatment liquid and the printing are performed by a single apparatus, the pretreatment liquid can be accurately applied to an area in which the image is to be printed. In addition, the amount of use of the pretreatment liquid can be reduced.

### SUMMARY

In an embodiment of the present disclosure, an image forming method includes applying a pretreatment liquid to a first area on an object having permeability, applying ink to the first area applied with the pretreatment liquid to form an image in the first area, the ink containing an organic solvent seeping into a second area around a circumference of the image in the first area and applying a colorless liquid containing water to the second area to diffuse the organic solvent in the second area.

In another embodiment of the present disclosure, an image forming apparatus includes a pretreatment-liquid applier to apply a pretreatment liquid to a first area on an object having permeability, an ink applier to apply ink to the first area applied with the pretreatment liquid to form an image in the first area, the ink containing an organic solvent seeping into a second area around a circumference of the image in the first area, and a colorless-liquid applier to apply a colorless liquid containing water to the second area to diffuse the organic solvent in the second area.

In still another embodiment of the present disclosure, an image forming apparatus includes a first carriage mounting the pretreatment-liquid applier and movable in a scanning direction, and a second carriage device mounting the ink applier and movable in the scanning direction parallel to the first carriage.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating components of an image forming apparatus, according to an embodiment of the present disclosure;

FIGS. 2A, 2B, 2C, and 2D are diagrams each illustrating a configuration of an image forming system according to an embodiment of the present disclosure;

FIGS. 3A, 3B, 3C, and 3D are diagrams each illustrating a configuration of a discharge head of an image forming apparatus, each incorporating a pretreatment-liquid discharge head as a pretreatment-liquid applier, according to an embodiment of the present disclosure;

FIGS. 4A and 4B are flowcharts each illustrating and comparing a process including a number of steps including a pretreatment-liquid application, according to a first comparative example and a second comparative example, respectively;

FIGS. 5A and 5B are diagrams each illustrating a relation between an area to which the pretreatment liquid is applied and an area on which the print image is formed, according to an embodiment of the present disclosure;

FIG. 6 is a diagram illustrating a case in which a trace of ink seepage is formed when the white ink is applied, according to an embodiment of the present disclosure;

FIGS. 7A and 7B are diagrams each illustrating a process in which the trace of ink seepage is formed as viewed from a cross section of a color cloth, according to an embodiment of the present disclosure;

FIG. 8A is a diagram illustrating a trace of ink seepage in a case in which an image is formed on a white cloth, according to a comparative example;

FIG. 8B is a diagram illustrating a trace of ink seepage in a case in which an image is formed on a color cloth by the comparative example;

FIG. 8C is a diagram illustrating a trace of ink seepage when an image is formed on a color cloth by the image forming method, according to an embodiment of the present disclosure;

FIGS. 9A is a flowchart of a process of reducing a trace of ink seepage in an image forming method according to a comparative example;

FIG. 9B is a flowchart of a process of an image forming method according to an embodiment of the present disclosure; FIGS. 9A and 9B are diagrams comparing the number of steps of the image forming method according to the comparative example and the number of steps of the image forming method according to an embodiment of the present disclosure;

FIG. 10 is a diagram illustrating an area to which the colorless liquid is applied on a color cloth, according to an embodiment of the present disclosure;

FIGS. 11A, 11B, 11C, and 11D are diagrams each illustrating a specific example of a colorless-liquid applier, according to an embodiment of the present disclosure; and

FIGS. 12A and 12B are photographs each illustrating a trace of ink seepage formed by an image forming method according to a comparative example and an image forming method according to an embodiment of the present disclosure, respectively.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An image forming method according to embodiments of the present disclosure includes a pretreatment-liquid application step in which a pretreatment liquid is applied to a predetermined area on an object to be printed having permeability, an ink application step in which ink is applied to an area to which the pretreatment liquid has been applied to form an image, and a colorless-liquid application step in which a colorless liquid containing water is applied to a predetermined area including an area around the image to which an organic solvent contained in the ink has seeped to diffuse the organic solvent. In addition, the image forming method includes a heating step in which an object to be printed is heated to vaporize and remove an excessive amount of water from the object to be printed to fix the ink onto the object to be printed.

The image forming apparatus according to embodiments of the present disclosure includes a pretreatment-liquid applier to apply a pretreatment liquid to a predetermined area on an object to be printed having permeability, an ink applier to apply ink to the predetermined area to which the pretreatment liquid has been applied to form an image, and a colorless-liquid applier to apply a colorless liquid containing water to a predetermined area including an area in which an organic solvent contained in the ink has exuded around the image to diffuse the organic solvent.

The image forming method according to embodiments of the present disclosure can be suitably performed by the image forming apparatus of the present disclosure. The pretreatment-liquid application step can be performed by the pretreatment-liquid applier. The ink application step can be performed by the ink applier, the colorless-liquid application step can be performed by the colorless-liquid applier, and the heating step can be performed by the heater.

The “object to be printed having permeability” in embodiments of the present disclosure is an object to be printed in which the pretreatment liquid and the ink applied to the surface of the object to be printed permeates into the inside of the object to be printed. Examples of such an object to be printed include a fabric. The cloth is a material obtained by forming fibers into, for example, a woven fabric, a knitted fabric, a woven fabric, a nonwoven fabric. The thickness of the fibers and the size of the mesh of the fibers are not limited.

Examples of the fiber are not limited and may be appropriately selected depending on the intended purpose. Examples of the fiber may include natural fibers, chemical fibers, biodegradable fibers, and mixed fibers of the natural fibers, the chemical fibers, or the biodegradable fibers.

Examples of the natural fibers include fibers made of cotton, hemp, wool, silk, and mixed fibers of the cotton, hemp, wool, or silk.

Examples of the chemical fibers include regenerated fibers, synthetic fibers, semi-synthetic fibers, and mixed fibers of the regenerated fibers, the synthetic fibers, or the semi-synthetic fibers.

Examples of the regenerated fibers include fibers made of viscose, lyocell, polynosic, rayon, cupra, and mixed fibers of the viscose, lyocell, polynosic, rayon, or cupra.

Examples of the synthetic fibers include fibers made of polypropylene, polyester, acetate, triacetate, polyurethane, polyamide, polyimide, acrylic, polyvinyl alcohol, polyvinyl chloride, nylon, Nomex (registered trademark, manufactured by Du Pont), Kevlar (registered trademark, manufactured by Du Pont), and blended fibers of the polypropylene, polyester, acetate, triacetate, polyurethane, polyamide, polyimide, acrylic, polyvinyl alcohol, polyvinyl chloride, nylon, Nomex, or Kevlar.

Examples of the semi-synthetic fibers include fibers made of acetate, diacetate, triacetate, and mixed fibers of the acetate, diacetate, or triacetate.

Examples of the biodegradable fibers include fibers made of polylactic acid.

Embodiments of the present disclosure can prevent trace of ink seepage that is caused by the organic solvent contained in white ink employed in a large amount as the base. Preferably, the object to be printed having permeability is a color cloth. A description is given of embodiments of the present disclosure below using an example in which the object to be printed having permeability is a color cloth.

In embodiments of the present disclosure, the “color cloth” is a cloth other than white fabric, and a black cloth is also included in the color cloth. Note that the pretreatment liquid and the color ink may seep on a white cloth. However, typically, a trace caused by the seepage is not conspicuous as a trace in many cases. However, when the trace is conspicuous even on a white cloth, the white cloth may be included as a color cloth.

A description is given below of the image forming method according to embodiments of the present disclosure.

### Pretreatment-Liquid Application Step

In the pretreatment-liquid application step, the pretreatment liquid is applied to a predetermined area including an area in which an image is formed on a color cloth. Applying the pretreatment liquid allows the ink to be likely to be fixed to the color cloth. Accordingly, the base can be formed using a large amount of white ink.

The pretreatment liquid according to embodiments of the present disclosure contains a coagulant for fixing the ink to the color cloth. The coagulant is a component that causes white ink or color ink to coagulate or thicken when the pretreatment liquid contacts the white ink or the color ink. Specific examples of the coagulant include a component that coagulates water-dispersible particles such as a colorant or resin contained in the white ink or color ink. Applying the pretreatment liquid containing such a coagulant onto the color cloth allows the white ink that has contacted the pretreatment liquid to be firmly fixed onto the color cloth. Accordingly, a base of the white ink can be formed.

The pretreatment-liquid applier performs the pretreatment-liquid application step. The pretreatment-liquid applier is not limited and may be appropriately selected depending on the intended purpose. Examples of the pretreatment-liquid applier include an inkjet head, a sprayer, a hand sprayer, a coating roller, and a brush.

When an inkjet head or a sprayer is employed as the pretreatment-liquid applier, the pretreatment-liquid applier and an ink applier described below can be incorporated as a single component. Accordingly, the size of the image forming apparatus can be reduced. In addition, incorporating the pretreatment-liquid applier and the ink applier described below in a single image forming apparatus and controlling the pretreatment-liquid applier and the ink applier allows the pretreatment liquid to be applied to only an area in which an image is to be applied. In other words, the amount of pretreatment liquid employed can be reduced.

In the pretreatment-liquid application step, the pretreatment liquid may be applied manually using, for example, a hand spray, an application roller, or a brush. Manually applying the pretreatment liquid allows the pretreatment liquid to be appropriately applied to an area as needed. Accordingly, the cost of the image forming apparatus can be reduced. By contrast, manually applying the pretreatment liquid depends on the skill of the operator. For this reason, the area and amount of the pretreatment liquid to be applied is not precisely controlled. In addition, preferably, the pretreatment liquid is applied to an area larger than the area in which the image is to be printed such that the ink reliably contacts the pretreatment liquid.

### Ink Application Step

In the ink application step, ink is applied to an area of a color cloth on which an image is to be formed, to form an image. The pretreatment liquid is applied in the pretreatment-liquid application step before the ink application step. By so doing, the ink is likely to be fixed on the color cloth.

The ink applier performs the ink application step. As the ink applier, typically, an inkjet head is employed.

When the ink is applied to the color cloth in the ink application step to form a color image, preferably a white ink is applied to form a base of the white ink, and a color ink is applied onto the base of the white ink to form a color image. The role of the white ink as a base is as follows.

First role: The white ink as the base removes the color of the color cloth and the texture of the surface of the color cloth to enhance the whiteness and smoothness of the color cloth as a canvas. The white ink as the base also serves to represent the white portion of the image.

Second role: The white ink as the base serves as an intermediate layer to physically receive the color ink.

The first role of the while ink allows correct color and gradation to be produced in color ink printing. In the second role, naturally from the order of the ink application step, the white ink serves as a base as an intermediate layer. However, the white ink layer needs to penetrate deep into the fibers of the color cloth to form a strong base. Preferably, the amount of the white ink four times or greater than the amount of the color ink is applied to enhance whiteness as color development, smoothness as a surface, and fastness of the cloth.

The white ink that is employed in embodiments of the present disclosure is a liquid composition which is applied to an object to be printed to be formed as a white color image. White color is a color referred to as white in the sense of common sense, and includes colors which are colored by a small amount of colors other than white.

The color ink that is employed in embodiments of the present disclosure is a liquid composition which is applied to an object to be printed to be formed as a color image. The color of the color ink is a color that is not included in the above-described white color, and includes, for example, black, cyan, magenta, and yellow.

The white ink and the color inks typically contain an organic solvent as a wetting agent. The wetting agent is a component that moisturizes ink to prevent the ink from drying. Examples of the wetting agent include glycerin and propanediol. When an inkjet head is employed as the ink applier, the ink containing a wetting agent prevents the ink from drying on the nozzle surface. Thus, the ejection stability of the ink is enhanced. By contrast, the wetting agent is a component having a high boiling point. The wetting agent remains on the color cloth even after the color cloth is heated to fix the ink on the color cloth. Accordingly, the ink containing the wetting agent may cause a trace of ink seepage to be formed around the image.

### Colorless-Liquid Application Step

In the colorless-liquid application step, a colorless liquid that contains water is applied to a predetermined area, which includes an area in which an organic solvent contained in the ink has seeped, around the image formed in the ink application step. Thus, the above-described organic solvent is diffused to the predetermined area. The organic solvent contained in the ink, in other words, the wetting agent has high water solubility. For this reason, the wetting agent is dissolved in the colorless liquid containing water and diluted. Thus, the ink is thin to an extent in which the trace of ink seepage is not recognized. The colorless-liquid application step of the present disclosure is a technology different from known technologies such as “humidity control” and “cleaning” as described below.

The humidity control is a process in which trace amounts of moisture are sprayed in an entire area in which printing is performed or to the entire surface of the cloth before printing. The humidity control can remove wrinkles of the cloth. In addition, the humidity control can cause the amount of moisture on the surface of the cloth to be uniform. By so doing, unevenness of ink penetration into the cloth can be eliminated. In addition, controlling the humidity in the entire area in which printing is performed can prevent the inkjet head from drying. Thus, the reliability of ink discharge can be enhanced. In comparison with the colorless-liquid application step of the present disclosure, the humidity control is a process in which trace amounts of moisture are sprayed only to adjust the humidity. For this reason, unlike the colorless-liquid application step of the present disclosure, the known humidity control does not remove trace of ink seepage.

The cleaning is a process of removing dirt and impurities generated while printing is performed, and is similar to the washing described above. When a sublimation dye ink is employed as the ink, a process in which the cloth is steamed and washed is needed to fix the ink onto the cloth. However, embodiments of the present disclosure employ a direct-to-garment (DTG) printing method using pigment ink. Accordingly, the process in which the cloth is steamed and washed is not needed. In comparison with the colorless-liquid application step of the present disclosure, washing the cloth after printing allows removal of the organic solvent and elimination of the trace of ink seepage. However, when washing and cleaning of the cloth is performed, waste liquid is generated, and drying and smoothing wrinkles are needed as subsequent processes.

The colorless-liquid applier performs the colorless-liquid application step. The colorless-liquid applier is not limited and may be appropriately selected depending on the intended purpose. However, from the viewpoint of preventing physical damage to an image to be formed, the colorless-liquid applier is preferably a unit that does not involve physical contact with an image to be formed. Examples of the colorless-liquid applier include an inkjet head, a sprayer, i.e., a compressor, a hand spray, a steam generator, and an immersion container.

The colorless liquid can be appropriately selected depending on the intended purpose as long as the colorless liquid includes water and satisfies all of the following conditions 1 to 4. However, pure water is preferable.
1. The color of the colorless liquid is not changed when the colorless liquid is adhesion to the image area or heated.
2. The boiling point of the colorless liquid is not higher than the heating temperature.
3. The colorless liquid does not contaminate a color cloth.
4. No deposition of solid matter (No solid matter is generated from the colorless liquid).

Examples of the colorless liquid other than pure water include an aqueous solution to which a fragrance component is added for the purpose of flavoring or deodorizing, and an aqueous solution to which a medicinal component is added for the purpose of disinfection such as sterilization and disinfection.

The colorless liquid is preferably applied by the colorless-liquid applier after the color ink is applied in the ink application step to form a color image. If the colorless liquid is applied before the color ink is applied, the pretreatment liquid on the color cloth is diluted, and the color ink does not sufficiently aggregate, which is not preferable.

### Heating Step

In the heating step, after the colorless liquid is applied, unnecessary moisture is evaporated and removed by heating. Thus, the ink is fixed to the color cloth. In the heating step, a heating and pressing step in which heating and pressurizing the color cloth are simultaneously performed may be performed.

The heater performs the heating step. The heater is not limited and may be appropriately selected depending on the intended purpose. Examples of the heater include a heat press machine that performs heating and pressurization simultaneously, a hot-air drying and fixing machine that blows hot air, and a conveyor heater that conveys a recording medium under a heat source by a conveyor.

Embodiments of the present disclosure are described in more detail below with reference to the drawings.

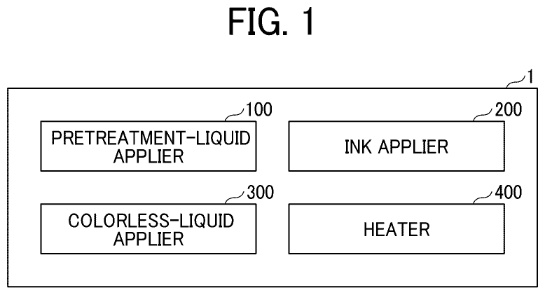

FIG. 1 is a schematic diagram illustrating components of an image forming apparatus 1 according to an embodiment of the present disclosure.

The image forming apparatus 1 includes a pretreatment-liquid applier 100, an ink applier 200, a colorless-liquid applier 300, and a heater 400.

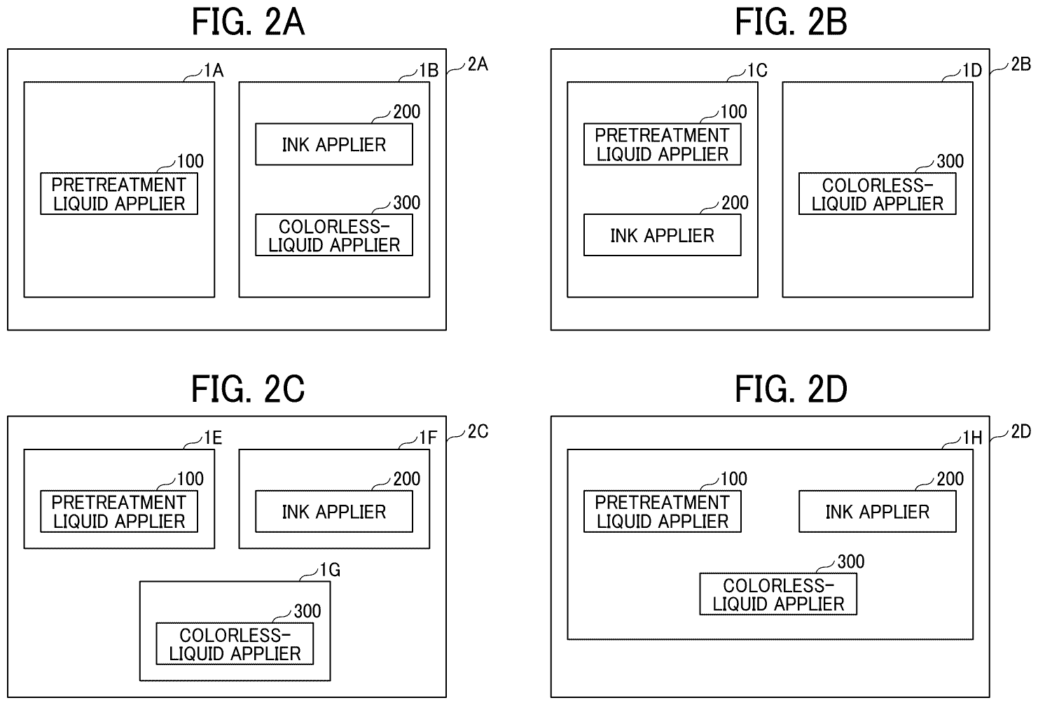

FIGS. 2A, 2B, 2C, and 2D are diagrams each illustrating a configuration of an image forming system, according to an embodiment of the present disclosure.

An image forming system 2A of FIG. 2A includes an apparatus 1A including the pretreatment-liquid applier 100 and an apparatus 1B including the ink applier 200 and the colorless-liquid applier 300.

An image forming system 2B of FIG. 2B includes an apparatus 1C including the pretreatment-liquid applier 100 and the ink applier 200, and an apparatus 1D including the colorless-liquid applier 300.

An image forming system 2C of FIG. 2C includes an apparatus 1E including the pretreatment-liquid applier 100, an apparatus IF including the ink applier 200, and an apparatus 1G including the colorless-liquid applier 300.

An image forming system 2D of FIG. 2D includes an apparatus 1H including the pretreatment-liquid applier 100, the ink applier 200, and the colorless-liquid applier 300.

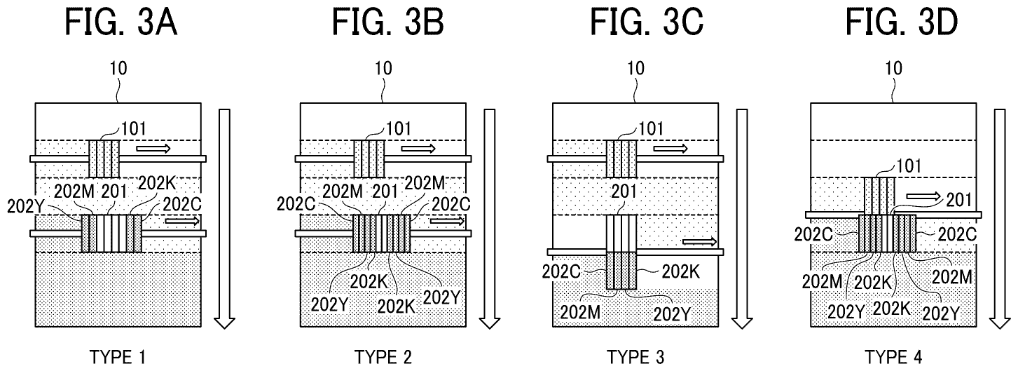

FIGS. 3A, 3B, 3C, and 3D are diagrams each illustrating a configuration of a discharge head type 1, a discharge head type 2, a discharge head type 3, and a discharge head type 4, respectively, of an image forming apparatus, each incorporating a pretreatment-liquid discharge head as a pretreatment-liquid applier.

Each of the discharge head types 1, 2, 3, and 4 illustrated in FIGS. 3A, 3B, 3C, and 3D, respectively, includes a pretreatment-liquid discharge head 101, a white-ink discharge head 201, and color-ink discharge heads, i.e., a yellow-ink discharge head 202Y, a magenta-ink discharge head 202M, a cyan-ink discharge head 202C, and a black-ink discharge head 202K. In FIGS. 3A, 3B, 3C, and 3D, a color cloth 10 is conveyed from the top to the bottom as indicated by the blank arrow. The pretreatment-liquid discharge head 101, the white-ink discharge head 201, the yellow-ink discharge head 202Y, the magenta-ink discharge head 202M, the cyan-ink discharge head 202C, and the black-ink discharge head 202K are arranged such that the pretreatment liquid is first discharged, then the white ink is discharged, and finally the color inks of cyan, magenta, yellow, and black are discharged to perform printing.

The white-ink discharge head 201 is disposed in the center of a carriage in a direction orthogonal to the direction in which the color cloth 10 is conveyed, except for the discharge head type 3. The carriage is a unit in which the pretreatment-liquid discharge head 101, the white-ink discharge head 201, the yellow-ink discharge head 202Y, the magenta-ink discharge head 202M, the cyan-ink discharge head 202C, and the black-ink discharge head 202K are collectively mounted. The white-ink discharge head 201 is disposed as described above such that the white ink is discharged first from the white-ink discharge head 201 disposed in the center of the carriage as a starting point and then the color inks are discharged from the respective discharge heads disposed at right and left sides of the white-ink discharge head 201 when bi-directional printing, in which printing is performed by scanning the heads both left and right, is performed. In FIGS. 3A, 3B, 3C, and 3D, the yellow-ink discharge head 202Y, the magenta-ink discharge head 202M, the cyan-ink discharge head 202C, and the black-ink discharge head 202K that contain four colors of cyan, magenta, yellow, and black, respectively, are disposed. However, the order in which the yellow-ink discharge head 202Y, the magenta-ink discharge head 202M, the cyan-ink discharge head 202C, and the black-ink discharge head 202K are arranged is not limited to the example of the discharge heads type 1, 2, 3, and 4. Color ink heads that contain photo inks such as light cyan, light magenta, and gray, and special color inks such as red, green, blue (RGB), orange, and violet may be mounted.

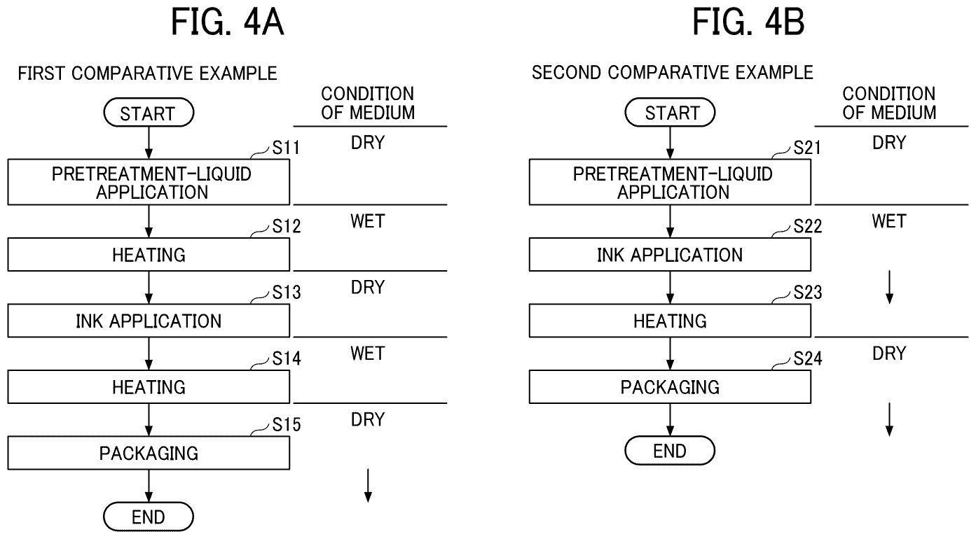

FIGS. 4A and 4B are flowcharts each illustrating and comparing a process including a number of steps including a pretreatment-liquid application, according to a first comparative example and a second comparative example, respectively.

The flowchart of FIG. 4A illustrates an image forming method according to the first comparative example in which a pre-treatment liquid application step (step S11) and an ink application step (step S13) are performed by different apparatuses. For this reason, preferably, a heating step (step S12) is performed between the pretreatment-liquid application step and the ink application step. This is because, to increase productivity, a stock of cloth to which the pretreatment liquid has been applied and dried to be printed with an image is prepared in advance, after the heating step (step S12) is performed. After the ink application step (step S13) is performed, the heating step (step S14) is performed again, and the packaging (step S15) is performed to complete the product.

Alternatively, the flowchart of FIG. 4B illustrates an image forming method, i.e., the second comparative example, of a printing apparatus which performs a pretreatment-liquid application step inside the printing apparatus, different from the image forming method of embodiments of the present disclosure. In the second comparative example, the pretreatment liquid application step (step S21) and the ink application step (step S22) can be performed continuously as a series of processes. Accordingly, the heating step between the pretreatment-liquid application step and the ink application step can be omitted. After the pretreatment liquid application step (step S21) and the ink application step (step S22) are performed, the heating step (step S23) is performed. Then, the packaging (step S24) is performed to complete the product. Compared with the first comparative example, the heating step is not performed in the second comparative example. Accordingly, a smaller number of steps is performed in the second comparative example and the second comparative example has higher productivity than the first comparative example. However, the object to be printed is wet from the pre-treatment liquid application step (step S22) to the ink application step (step S23), and thus a trace of ink seepage due to the spreading of the ink may be formed outside the printing area when a large amount of white ink is employed as a base.

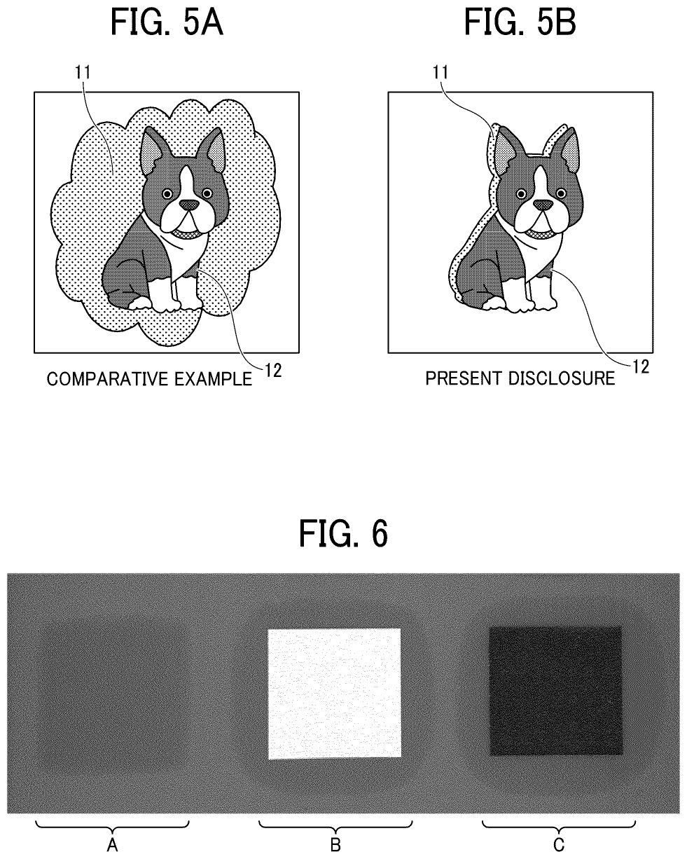

FIGS. 5A and 5B are diagrams each illustrating a relation between an area to which the pretreatment liquid is applied and an area on which the print image is formed.

FIG. 5A is a diagram illustrating an area onto which the pretreatment liquid is applied by a known image forming method. In the known image forming method, the pretreatment-liquid application step is performed by a device different from a device that performs the ink application step, or is performed manually such as by hand spraying, brushing, or rolling. For this reason, in many cases, an area in which a print image 12 is to be formed is unknown when the pretreatment-liquid application step is performed. Accordingly, the pretreatment liquid is applied to a wide range of color cloth such that the ink for forming the print image 12 contacts the pretreatment liquid. Accordingly, a pretreatment liquid application area 11 spreads widely to the outside of the formed print image 12, and in some cases, a trace of ink seepage caused by the pretreatment liquid as occurred in the comparative example may occur due to unevenness when the pretreatment liquid is applied.

By contrast, FIG. 5B illustrates the pretreatment liquid application area 11 formed by the image forming method according to an embodiment of the present disclosure. The image forming apparatus according to an embodiment of the present disclosure, includes an image forming device incorporating a pretreatment liquid discharge head. Accordingly, the pretreatment-liquid application step and the ink application step are performed inside the single image forming apparatus. By so doing, the pretreatment liquid can be accurately discharged onto the pretreatment liquid application area 11 in accordance with an area in which the print image 12 is formed. Accordingly, in the image forming apparatus according to embodiments of the present disclosure, the amount of the pretreatment liquid employed can be reduced. In addition, the trace of ink seepage caused by the pretreatment liquid is not formed. In FIG. 5B, the pretreatment liquid application area 11 is illustrated at a position shifted from the print image 12 to illustrate the pretreatment liquid application area 11. However, the pretreatment liquid is applied to an area that is sufficiently coincident with the print image 12.

FIG. 6 is a diagram illustrating a case in which a trace of ink seepage is formed when the white ink is applied.

FIG. 6 is a diagram illustrating photographs of areas A, B, and C on a color cloth after the following processes were performed and then the heating step was performed by the heating and pressing device.

Area A: Only the pretreatment-liquid application step was performed to apply the pretreatment liquid onto the color cloth.

Area B: A white ink was further applied to form a base onto the area A onto which the pretreatment liquid has been applied.

Area C: On top of the area B, a color ink was further applied to form a color image. Any of the areas A, B, and C, can be recognized as an area in which the trace of ink seepage is imaged darker than the color of the cloth. When the traces of ink seepage in the areas A and B are compared, the trace of ink seepage in the area B is more widely spread, and it can be confirmed that the influence of the use of a large amount of white ink is large. By contrast, there is almost no difference in the size of the trace of ink seepage between the areas B and C, and it can be confirmed that the formation of the color image by the color ink does not greatly affect the trace of ink seepage.

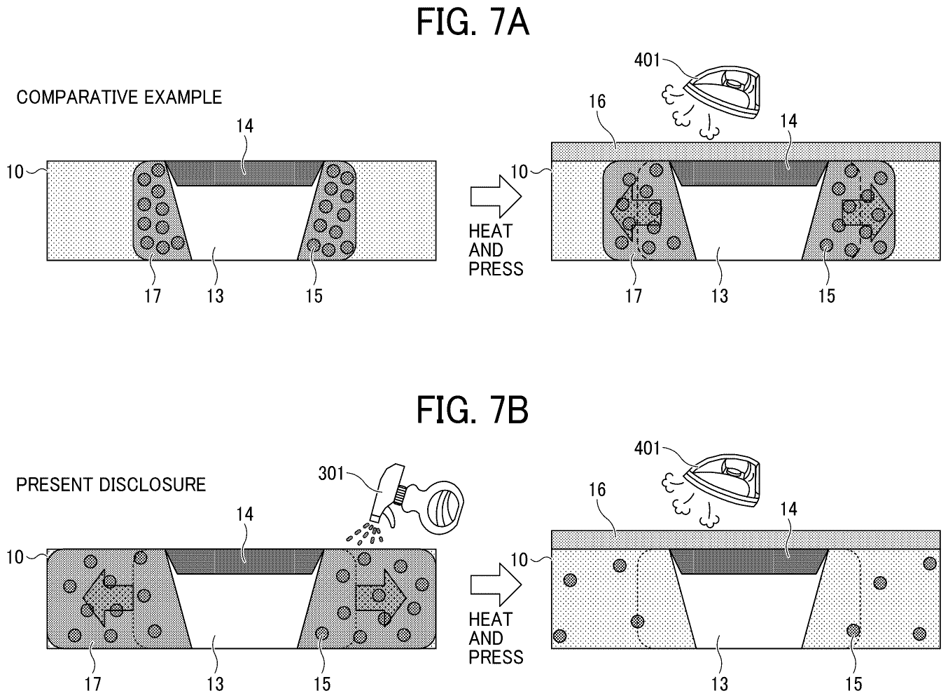

FIGS. 7A and 7B are diagrams each illustrating a process in which the trace of ink seepage is formed as viewed from a cross section of the color cloth. FIG. 6 illustrates an example in which a heating and pressing device 401 is employed as the heater.

FIG. 7A is a diagram illustrating a process in which the trace of ink seepage 17 is formed in the image forming method according to a comparative example. In the comparative example, the white ink 13 and the color ink 14 immediately after the ink application step, and the organic solvent 15 derived from the white ink 13 are distributed on the color cloth 10 as illustrated in the left portion of FIG. 7A. FIG. 7A is a schematic diagram illustrating the presence of the organic solvent. For this reason, the organic solvent 15 indicated by the white circle in FIG. 7 does not indicate the shape of the organic solvent. The white ink 13 and the color ink 14 immediately after the ink application step have undergone an aggregation reaction due to the pretreatment liquid. However, the white ink 13 and the color ink 14 are only loosely solidified on the color cloth 10 until the white ink 13 and the color ink 14 are thermally cured by the heating step. The white ink 13 and the color ink 14 that are not yet sufficiently thermally cured are likely to peel off by physical force. However, the white ink 13 and the color ink 14 that are not yet sufficiently thermally cured are unlikely to peel off by the movement of moisture of the white ink 13 and the color ink 14 during the heating step.

In the heating step, the heating and pressing device 401 heats and presses the white ink 13 and the color ink 14. By so doing, the white ink 13 and the color ink 14 are thermally cured to be firmly fixed to the cloth. When the heating and pressing device 401, which causes a heat source to contact the white ink 13 and the color ink 14 to heat the white ink 13 and the color ink 14, is employed, a heating and pressing step is performed in which an impermeable sheet 16 such as a kitchen paper, or a Teflon (registered trademark) sheet, is disposed on the white ink 13 and the color ink 14 such that an image formed with the white ink 13 and the color ink 14 does not peel off by being attached to the heat source. A side of the color cloth 10 on which the image is formed is sealed with the impermeable sheet 16 and the opposite side of the color cloth 10 is sealed with the heat and the pressing force from the heating and pressing device 401. Accordingly, the moisture of the white ink 13 and the color ink 14 evaporated by heating escapes in the planar direction of the color cloth 10. At this time, the organic solvent 15 also moves inside the color cloth 10 together with the moisture.

The temperature of the heating and pressing device 401 is set to a temperature at which the color cloth 10 is not damaged, i.e., not melted or thermally denatured, and at which the moisture can be removed. For example, when the color cloth 10 is a polyester cloth, the temperature is set to about 100 to 120° C. All the moisture evaporates by the heating and pressing step using the heating and pressing device 401. However, the organic solvent 15 has a high boiling point (for example, glycerin has a boiling point of about 290° C., and propanediol has a boiling point of about 190° C.). As a result, the organic solvent 15 remains inside the color cloth 10 as is, and a trace of ink seepage is formed.

FIG. 7B is a diagram illustrating a mechanism that reduces the trace of ink seepage by the image forming method of the present disclosure. When the heating and pressing step is performed by the heating and pressing device 401, the organic solvent 15 diffuses on the color cloth 10 together with the evaporated moisture. By using this phenomenon, applying additionally a colorless liquid onto the color cloth 10 can reduce the concentration of the organic solvent 15 on the color cloth 10. FIG. 7B illustrates a case in which water is sprayed using a hand spray 301 as the colorless-liquid applier. The organic solvent 15 diffuses in a wide range on the color cloth 10 by the application of water and the heating and pressing step by the heating and pressing device 401. Accordingly, the concentration of the organic solvent 15 can be reduced to such an extent that the organic solvent 15 is not recognized as a trace of ink seepage.

As a concern at this time, the print image may be damaged, i.e., thinned, blurred, flowed, or shaved, due to the application of water. The white ink 13 and the color ink 14 are only loosely solidified on the color cloth 10 immediately after the ink application step. For this reason, strongly spraying or pouring water on the color cloth 10 may damage the print image and deteriorate printing quality. Water is applied to the surface of the print image in a non-contact manner, or spraying water to the surface of the print image at an angle at which deflecting impact to the print image is deflected, or fine spray droplets are sprayed to reduce the impact on the print image. By so doing, water can be applied to the print image without damaging the print image.

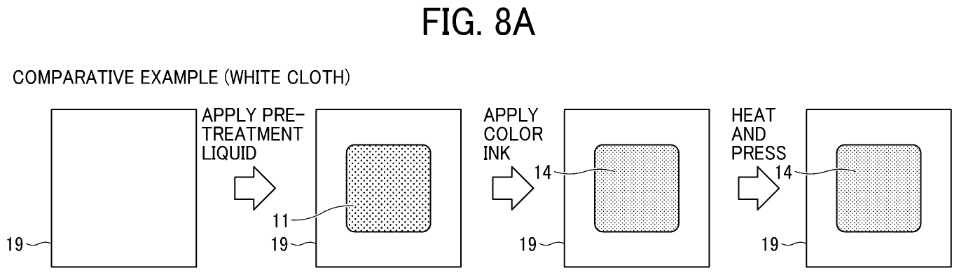

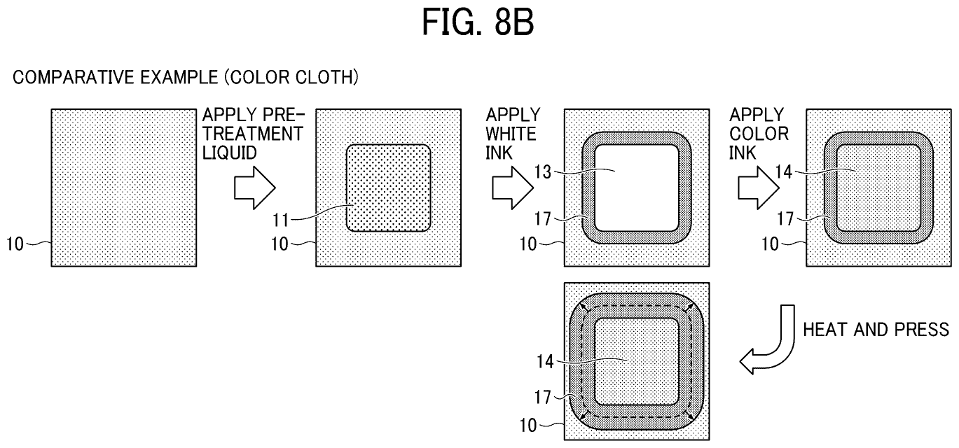

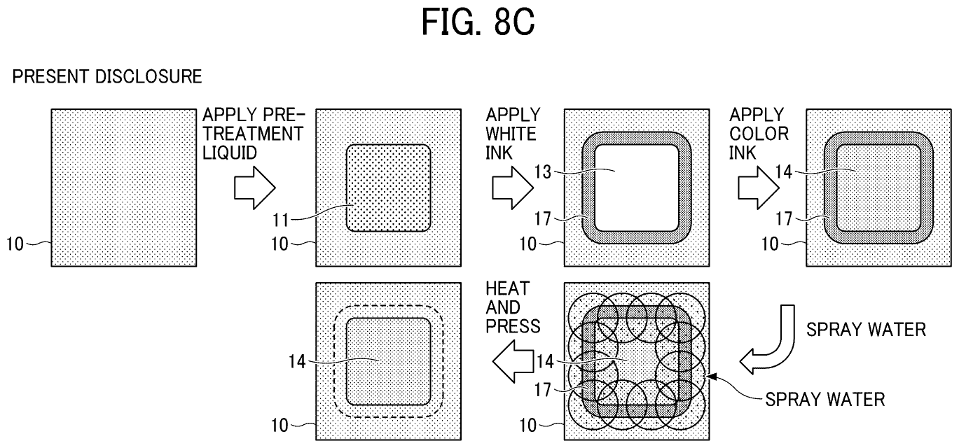

FIGS. 8A, 8B, and 8C are schematic diagrams each illustrating the contents of FIG. 7 as viewed from the front side of the cloth.

FIG. 8A is a diagram illustrating a trace of ink seepage in a case in which an image is formed on a white cloth according to the comparative example. In this case, a base is not formed on a white cloth 19, a large amount of white ink is not used and, a smaller amount of pretreatment liquid is sufficient than a case in which printing is performed on a color cloth, and no trace of ink seepage is formed.

FIG. 8B is a diagram illustrating a trace of ink seepage in the case in which an image is formed on a color cloth by the comparative example. FIG. 8B corresponds to FIG. 7A, and the trace of ink seepage 17 is formed around the area in which the white ink 13 is applied. The trace of ink seepage 17 is finally heated and pressed by the heating and pressing device 401. By so doing, the trace of ink seepage 17 is further enlarged.

FIG. 8C is a diagram illustrating a trace of ink seepage when an image is formed on a color cloth by the image forming method, according to an embodiment of the present disclosure. FIG. 8C corresponds to FIG. 7B. Water is sprayed to the trace of ink seepage 17 after the color ink 14 is applied. By so doing, the organic solvent which is the cause of the trace of ink seepage 17 is diffused on the color cloth 10. The organic solvent is further diffused widely on the color cloth 10 after the color cloth 10 is heated and pressed by the heating and pressing device 401. By so doing, the concentration of the organic solvent is reduced to such an extent that the organic solvent is not recognized as a trace of ink seepage.

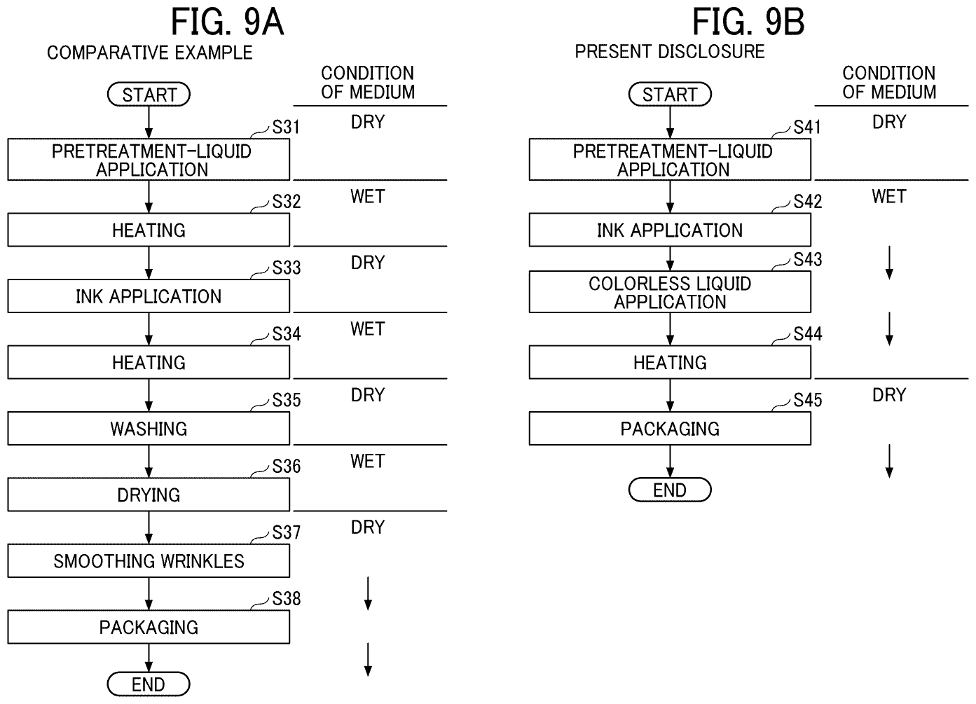

FIGS. 9A is a flowchart of a process of reducing a trace of ink seepage in an image forming method according to a comparative example. FIG. 9B is a flowchart of a process of an image forming method according to an embodiment of the present disclosure. FIGS. 9A and 9B are illustrated to compare the number of steps of the image forming method according to the comparative example and with the number of steps of the image forming method according to an embodiment of the present disclosure.

FIG. 9A is a flowchart of an image forming method according to the comparative example. Washing (step S35) is performed to reduce the trace of ink seepage. Subsequently, drying (step S36) and smoothing wrinkles (step S37) are performed as additional processes to obtain a product. Accordingly, the total number of processes increases and the productivity is low.

FIG. 9B illustrates the flowchart of the image forming method according to an embodiment of the present disclosure. By contrast to the flowchart of FIG. 9A, in the flowchart of FIG. 9B, the colorless-liquid application step (step S43) is performed to reduce the trace of ink seepage. Accordingly, the processes of washing, drying and smoothing wrinkles, which are needed in the comparative example, are not needed in embodiments of the present disclosure.

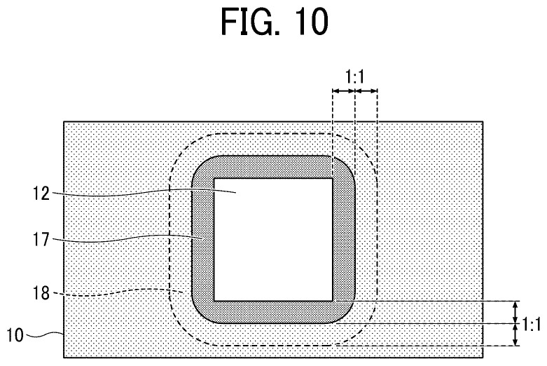

FIG. 10 is a diagram illustrating an area to which the colorless liquid is applied on the color cloth 10.

The width of the colorless liquid application area 18 is preferably twice or greater than the width of the trace of ink seepage 17. When the ratio between the width of the colorless liquid application area 18 and the is equal to or greater than two or greater than the width of the trace of ink seepage 17. By so doing, the organic solvent is diffused on the color cloth 10 to such an extent that the trace of ink seepage is not recognized. The colorless-liquid application area 18 may include an area in which the print image 12 is formed or the entire surface of the color cloth 10 as long as the print image 12 is not physically damaged.

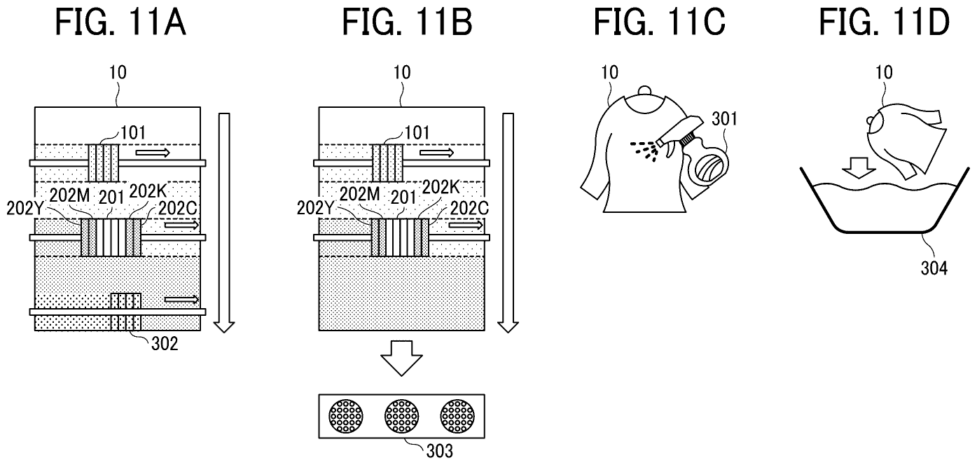

FIGS. 11A, 11B, 11C, and 11D are diagrams each illustrating a specific example of the colorless-liquid applier.

FIG. 11A is a diagram illustrating a carriage which includes not only the pretreatment-liquid discharge head 101 but also a colorless-liquid discharge head 302 as a colorless-liquid applier, according to an image forming method of the present disclosure. The colorless-liquid discharge head 302 as the colorless-liquid applier is employed in the image forming method. By so doing, similar to the pretreatment liquid, the colorless liquid can be applied to a predetermined area of the color cloth 10. The carriage according to the image forming method of the present embodiment has a simple configuration in which the pretreatment-liquid discharge head 101, the white-ink discharge head 201, the yellow-ink discharge head 202Y, the magenta-ink discharge head 202M, the cyan-ink discharge head 202C, and the black-ink discharge head 202K, and the colorless liquid discharge head 302 are arranged in parallel. Accordingly, the image forming apparatus can be downsized. In addition, the colorless-liquid discharge head 302, which is incorporated in the carriage, may contain a transparent ink and the transparent ink may be employed as the colorless liquid.

FIG. 11B is a diagram illustrating an image forming method using a carriage and a colorless-liquid sprayer 303 as a separate device from the image forming apparatus. Examples of spraying method include a method of discharging liquid pressurized by a compressor from a nozzle, and a method of generating a mist of a colorless liquid by a heater or ultrasonic vibration and spraying the mist to the color cloth 10. The colorless-liquid sprayer 303 may be a handy device or may be integrated with a device for performing a subsequent heating step.

FIG. 11C is a diagram illustrating a method in which the colorless liquid is manually sprayed using the hand spray 301 as the colorless-liquid applier. When the hand spray 301 is employed, depending on a model to be used, the strength of water flow, the size of water droplets, and whether water droplets drip from a nozzle of the hand spray. For this reason, it is preferable to use the hand spray 301 carefully. In addition, the spraying is performed manually. For this reason, it is preferable to pay attention to conditions such as a spraying angle. However, this method using the hand spray 301 can be performed at the lowest cost. FIG. 11D is a diagram illustrating a method in which an immersion container 304 is employed as the colorless-liquid applier to slowly immerse the color cloth 10 in the colorless liquid from the side of the color cloth 10 on which a print image is formed. The immersion container 304 may be installed in a conveyance path of the color cloth 10, and the color cloth 10 may be immersed in the colorless liquid by hand in addition to a method in which the color cloth 10 is automatically immersed in the colorless liquid. However, as compared with the methods illustrated in FIGS. 11A, 11B, and 11C, the method of FIG. 11D takes time to dry the colorless liquid because an area of the color cloth 10 wetted by the application of the colorless liquid is large.

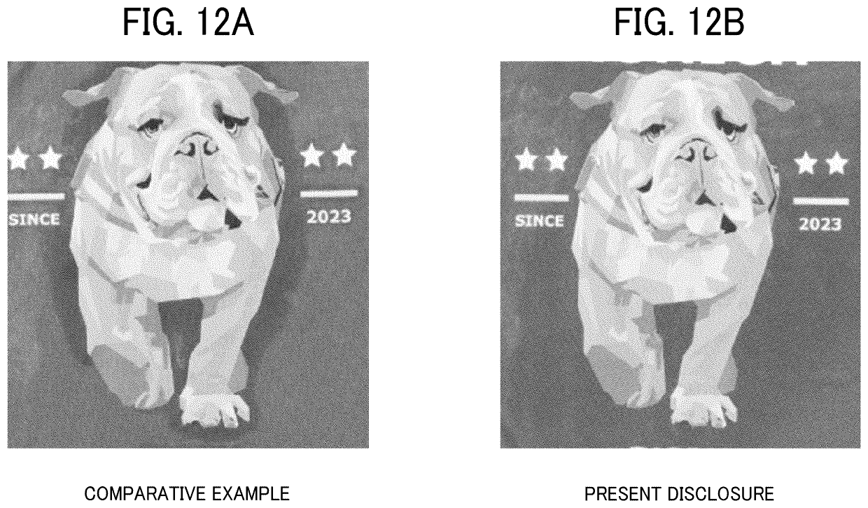

FIGS. 12A and 12B are photographs each illustrating a trace of ink seepage formed by the image forming method according to the comparative example and the image forming method according to an embodiment of the present disclosure, respectively. Image processing was performed on both of the photographs such that the trace of ink seepage was easily recognized. It can be seen that the trace of ink seepage that is recognized around the print image in the comparative example is substantially invisible in the method of the present disclosure.

Aspects of the present disclosure are, for example, as follows.

### First Aspect

An image forming method includes a pretreatment-liquid application step in which a pretreatment liquid is applied to a predetermined area on an object to be printed having permeability, an ink application step in which ink is applied to the area to which the pretreatment liquid has been applied to form an image, and a colorless-liquid application step in which a colorless liquid containing water is applied to a predetermined area including an area in which an organic solvent contained in the ink has seeped, around the image, to diffuse the organic solvent.

### Second Aspect

The image forming method according to the first aspect, further includes a heating step in which the ink is heated after the colorless liquid is applied to evaporate and remove unnecessary moisture from the ink, and to fix the ink to the object to be printed.

### Third Aspect

In the image forming method according to the first or second aspect, in the ink application step, a white ink is applied to a predetermined area including the area to which the pretreatment liquid has been applied to form a base with the white ink, and a color ink is applied to a predetermined area on a base to which the white ink is applied to form a color image.

### Fourth Aspect

An image forming apparatus includes a pretreatment-liquid applier that applies a pretreatment liquid to a predetermined area on an object to be printed having permeability, an ink applier that applies ink to an area to which the pretreatment liquid has been applied to form an image, and a colorless-liquid applier that applies a colorless liquid containing water to a predetermined area including an area around the image, in which an organic solvent contained in the ink has seeped, to diffuse the organic solvent.

### Fifth Aspect

The image forming apparatus according to the fourth aspect, further includes a heater that heats the object to be printed to which the colorless liquid has been applied to evaporate and remove unnecessary moisture to fix the ink to the object to be printed.

### Sixth Aspect

In the image forming apparatus according to the fourth or fifth aspect, the ink applier applies a white ink to a predetermined area including an area to which the pretreatment liquid has been applied to form a base with the white ink, and applies a color ink to a predetermined area of a base to which the white ink has been applied to form a color image.

### Seventh Aspect

An image forming system includes an apparatus including a pretreatment-liquid applier that applies a pretreatment liquid to a predetermined area on an object to be printed having permeability, and an apparatus including an ink applier that applies ink to a predetermined area including an area to which the pretreatment liquid has been applied to form an image, and a colorless-liquid applier that applies a colorless liquid containing water to a predetermined area including an area around the image, in which an organic solvent contained in the ink has seeped, to diffuse the organic solvent.

### Eighth Aspect

In the image forming system according to the seventh aspect, the ink applier applies a white ink to a predetermined area including an area to which the pretreatment liquid has been applied to form a base with the white ink, and applies a color ink to a predetermined area of the base to which the white ink has been applied to form a color image.

### Nineth Aspect

An image forming system includes an apparatus including a pretreatment-liquid applier that applies a pretreatment liquid to a predetermined area on an object to be printed having permeability, and an ink applier that applies ink to a predetermined area including the area to which the pretreatment liquid has been applied to form an image, an apparatus including a colorless-liquid applier that applies a colorless liquid containing water to a predetermined area, around the image, including an area in which an organic solvent contained in the ink has seeped, to diffuse the organic solvent.

### Tenth Aspect

In the image forming system according to the nineth aspect, the ink applier applies a white ink to a predetermined area including an area to which the pretreatment liquid has been applied to form a base with the white ink, and applies a color ink to a predetermined area of the base to which the white ink has been applied to form a color image.

### Eleventh Aspect

An image forming system includes an apparatus including a pretreatment-liquid applier that applies a pretreatment liquid to a predetermined area on an object to be printed having permeability, an ink applier that applies ink to a predetermined area including an area to which the pretreatment liquid has been applied to form an image, and an apparatus including a colorless-liquid applier that applies a colorless liquid containing water to a predetermined area, around the image, including an area in which an organic solvent contained in the ink has seeped, to diffuse the organic solvent.

### Twelfth Aspect

In the image forming system according to the eleventh aspect, the ink applier applies a white ink to a predetermined area including an area to which the pretreatment liquid has been applied to form a base with the white ink, and applies a color ink to a predetermined area of the base to which the white ink has been applied to form a color image.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

1. An image forming method comprising:
applying a pretreatment liquid to a first area on an object having permeability;
applying ink to the first area applied with the pretreatment liquid to form an image in the first area, the ink containing an organic solvent seeping into a second area around a circumference of the image in the first area; and
applying a colorless liquid containing water to the second area to diffuse the organic solvent in the second area.

2. The image forming method according to claim 1, further comprising:
heating the object applied with the colorless liquid to evaporate and remove moisture from the object to fix the ink to the object.

3. The image forming method according to claim 1,
wherein the applying the ink:
applies a white ink to the first area applied with the pretreatment liquid to form a base with the white ink; and
applies a color ink onto the base with the white ink in the first area to form a color image on the base.

4. An image forming apparatus comprising:
a pretreatment-liquid applier to apply a pretreatment liquid to a first area on an object having permeability;
an ink applier to apply ink to the first area applied with the pretreatment liquid to form an image in the first area, the ink containing an organic solvent seeping into a second area around a circumference of the image in the first area; and
a colorless-liquid applier to apply a colorless liquid containing water to the second area to diffuse the organic solvent in the second area.

5. The image forming apparatus according to claim 4, further comprising
a heater to heat the object applied with the colorless liquid to evaporate and remove moisture of the object to fix the ink to the object.

6. The image forming apparatus according to claim 4,
wherein the ink applier applies:
a white ink to the first area applied with the pretreatment liquid to form a base with the white ink; and
a color ink onto the base with the white ink in the first area to form a color image on the base.

7. The image forming apparatus according to claim 4, further comprising:
a first carriage mounting the pretreatment-liquid applier and movable in a scanning direction; and
a second carriage device mounting the ink applier and movable in the scanning direction parallel to the first carriage.

8. The image forming apparatus according to claim 7,
wherein the ink applier:
applies a white ink to the first area applied with the pretreatment liquid to form a base with the white ink; and
applies a color ink onto the base with the white ink in the first area to form a color image on the base.

9. The image forming apparatus according to claim 4,
wherein the colorless-liquid applier includes a sprayer including a nozzle from which the colorless liquid is discharged.

10. The image forming apparatus according to claim 9,
wherein the ink applier applies:
a white ink to the first area applied with the pretreatment liquid to form a base with the white ink; and
a color ink onto the base with the white ink to form a color image on the base.

11. The image forming apparatus according to claim 4, further comprising:
a first carriage mounting the pretreatment-liquid applier and movable in a scanning direction;
a second carriage mounting the ink applier and movable in the scanning direction parallel to the first carriage; and
a third carriage mounting the colorless-liquid applier and movable in the scanning direction parallel to the first carriage and the second carriage.

12. The image forming apparatus according to claim 11,
wherein the ink applier:
applies a white ink to the first area applied with the pretreatment liquid to form a base with the white ink; and
applies a color ink onto the base with the white ink in the first area to form a color image on the base.
